(19) United States
(12) Patent Application Publication
(10) Pub. No.: US 2022/0069766 A1
(43) Pub. Date: Mar. 3, 2022

(54) SOLAR ENERGY CONTAINER SYSTEM AND METHODS

(71) Applicant: The Sovereign Corporation, Mableton, GA (US)

(72) Inventor: Chris Mullings, Mableton, GA (US)

(73) Assignee: The Sovereign Corporation, Mableton, GA (US)

(21) Appl. No.: 17/007,309

(22) Filed: Aug. 31, 2020

(51) Int. Cl. H02S 40/38; B65D 88/12; B65D 90/00; H02S 10/40; H02S 40/34; B60L 8/00; B60L 50/60; B60K 6/28; B60K 35/00

(52) U.S. Cl. CPC H02S 40/38; B65D 88/121; B65D 90/00; H02S 10/40; H02S 40/34; B60L 8/003; B60Y 2300/91; B60K 6/28; B60K 35/00; B65D 2590/0083; B60K 2370/171; B60Y 2200/91; B60Y 2200/92; B60L 50/66

(57) ABSTRACT

The present disclosure describes a solar energy storage system. A storage container is provided, comprising a base having a compartment defined by a planar exterior surface and a planar interior service and a battery stored in the compartment of the base. A plurality of solar panels are operably coupled to an exterior surface of the container and electrically coupled to the battery. At least one access panel disposed in the exterior corners of the top and base and at least one plug receptacle disposed behind the at least one access panel such that each access panel is associated with one plug receptacle. The at least one plug receptacle is electrically coupled to the battery. The plurality of solar panels are configured to receive sunlight and convert to solar energy for storage in the battery and supply energy to electric vehicles during transport of the container(s).

### FIELD

The present disclosure generally relates to the technical field of electrical systems and transportation. More specifically, the present disclosure is directed to a solar energy cargo system capable of receiving and storing solar energy, and powering electric or hybrid electric vehicles using the received solar energy.

### BACKGROUND

An intermodal container is a large standardized shipping container, designed and built for intermodal freight transport, meaning these containers can be used across different modes of transport—from ship to rail to truck—without unloading and reloading their cargo. Terminology associated with intermodal containers may include such names as container, cargo or freight container, ISO container, shipping, sea or ocean container, sea van or (Conex) box, sea can or c can.

ISO 6346, developed by the International Container Bureau, is an international standard covering the coding, identification and marking of intermodal (“shipping”) containers used within containerized intermodal freight transport. The ISO 6346 international standard establishes a visual identification system for every container that includes a unique serial number (with check digit), the owner, a country code, a size, type and equipment category as well as any operational marks.

Similar to cardboard boxes and pallets, these containers are a means to bundle cargo and goods into larger, unitized loads, that can be easily handled, moved, and stacked, and that will pack tightly in a ship or yard. Currently, intermodal containers are made of metal and designed to be durable. Intermodal containers share a number of key construction features to withstand the stresses of intermodal shipping, to facilitate their handling and to allow stacking, as well as being identifiable through their individual unique ISO 6346 reporting mark.

Advances is solar powered technology have increased the durability and structure of solar panels. There are two main types of solar technology: photovoltaics (PV) and concentrated solar power (CSP). Solar PV technology captures sunlight to generate electric power, and CSP harnesses the sun's heat and uses it to generate thermal energy that powers heaters or turbines. Solar PV technology has improved significantly in the last 20 years. By way of example, solar PV panels can be outfitted with “solar skin”, as described in U.S. Pat. No. 10,256,360, that makes it possible for solar panels to have a customized aesthetic without interfering with efficiency or production. Furthermore, efficiency for solar PV panels has increased tremendously. By way of example, Perovskite solar cells, as compared to silicon cells, have seen major breakthroughs, generating 20+ percent efficiency.

In conjunction with the advances in solar powered technology, battery technology has improved tremendously in the past decade. With the advent of the lithium-ion battery and other innovative battery technologies, storage of solar energy is becoming increasingly more efficient and affordable. Alternatively, solar thermal fuels can be used to harness sunlight energy, store it as a charge and then release it when prompted. As opposed to battery technologies, the solar energy harnessed by solar thermal fuels can store power as a liquid substance.

Intermodal container design has not changed significantly since the late 1940s. A majority of intermodal containers are stored and/or shipped exposed to the environment. It would be advantageous to configure an intermodal container such that it can receive solar energy and store that energy for future use. Moreover, with the advent of electric vehicles, it would be advantageous to be able to utilize the energy received and stored on intermodal containers to supplement electric vehicle propulsion. Finally, embodiments of the present disclosure provide that intermodal containers may be capable of receiving and storing solar energy and electrically coupled together to form a primary source of energy for electric vehicles.

### SUMMARY

According to various embodiments, the present disclosure describes a storage container, comprising a plurality of walls coupled to one another to form a storage chamber therebetween and to define a plurality of intersection edges being formed at a corresponding boundary of two adjacent ones of the plurality of walls. The container further comprises a base having a compartment defined by a planar exterior surface and a planar interior service; a top, wherein said plurality of walls extend substantially vertically from the base to the top; a battery stored in the compartment of the base; a plurality of solar panels operably coupled to an exterior surface of the plurality of walls and electrically coupled to the battery; at least one access panel disposed in the exterior corners of the top and base; and at least one plug receptacle disposed behind the at least one access panel such that each access panel is associated with one plug receptacle, wherein the at least one plug receptacle is electrically coupled to the battery. According to various embodiments, the plurality of solar panels are configured to receive sunlight and convert to solar energy for storage in the battery.

According to various embodiments, a solar energy storage system is disclosed. The solar energy system comprises at least one container. The at least one container comprises a top, a bottom, and a plurality of sides; at least one solar panel operably coupled to at least one of the plurality of sides of the at least one container; a battery disposed with an interior cavity of the at least one container and electrically coupled to the at least one solar panel; wherein the at least one solar panel is configured to receive sunlight and convert to solar energy for storage in the battery.

A method of powering an engine capable of receiving electricity is disclosed. The method comprises the steps of: receiving solar energy via at least one solar panel operably coupled to the exterior surface of a first intermodal container; storing the solar energy received via the at least one solar panel in a battery disposed within an interior cavity of a container; and supplying power to an electric or hybrid electric engine using the stored solar energy from the battery.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1A is a front side view of an intermodal container in accordance with some embodiments of the present disclosure.

FIG. 1B is an alternative front side view of an intermodal container in accordance with some embodiments of the present disclosure.

FIG. 1C is an interior side view of an intermodal container in accordance with some embodiments of the present disclosure.

FIG. 2 is an intermodal container operably coupled to a truck in accordance with some embodiments of the present disclosure.

FIG. 3 is a plurality of intermodal containers disposed on a container ship in accordance with some embodiments of the present disclosure.

FIG. 4 is a plurality of intermodal containers disposed on railroad car in accordance with some embodiments of the present disclosure.

FIG. 4A is a plurality of intermodal containers disposed on each other on railroad car in accordance with some embodiments of the present disclosure.

### DETAILED DESCRIPTION

With reference to the figures, where like elements have been given like numerical designations to facilitate an understanding of the drawings, various embodiments of a system and method are described. The figures are not drawn to scale.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

This description of illustrative embodiments is intended to be read in connection with the accompanying drawings, which are to be considered part of the entire written description. The drawing figures are not necessarily to scale and certain features of the invention can be shown exaggerated in scale or in somewhat schematic form in the interest of clarity and conciseness. In the description of embodiments disclosed herein, any reference to direction or orientation is merely intended for convenience of description and is not intended in any way to limit the scope of the present disclosure. Relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” “interconnected,” “attached,” and “affixed,” refer to a relationship wherein structures are secured or attached to one another either directly or indirectly through intervening structures, as well as both movable or rigid attachments or relationships, unless expressly described otherwise. The terms “operatively connected” or operatively coupled” are such an attachment, coupling or connection that allows the pertinent structures to operate as intended by virtue of that relationship. The term “adjacent” as used herein to describe the relationship between structures/components includes both direct contact between the respective structures/components referenced and the presence of other intervening structures/components between respective structures/components.

As used herein, use of a singular article such as “a,” “an” and “the” is not intended to exclude pluralities of the article's object unless the context clearly and unambiguously dictates otherwise.

The present disclosure is describes an intermodal container having solar PV panels for use in in receiving solar energy. In various embodiments, the intermodal containers further comprise a battery for storing energy received and collected from the solar PV panels. In some embodiments, the intermodal containers described herein may be electrically coupled to each other and/or capable of supplying power to electric vehicles. As will be further explained, although the term intermodal container is used, this disclosure is not limited to intermodal containers, and any type of container may be used as disclosed in the embodiments herein. As an example, a fifty-two inch tractor trailer truck may be understood as a container and/or intermodal container sufficient to encompass the embodiments of this disclosure.

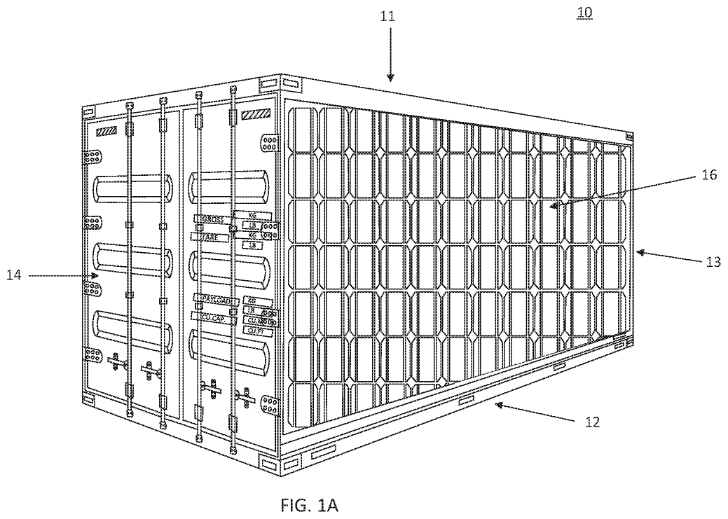

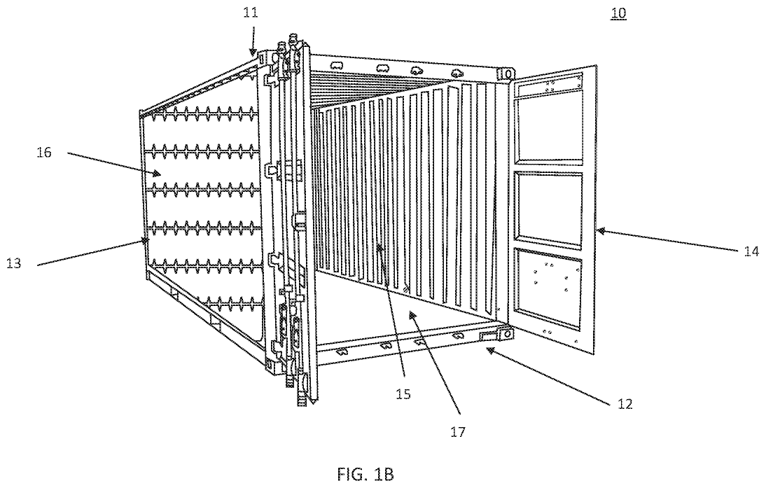

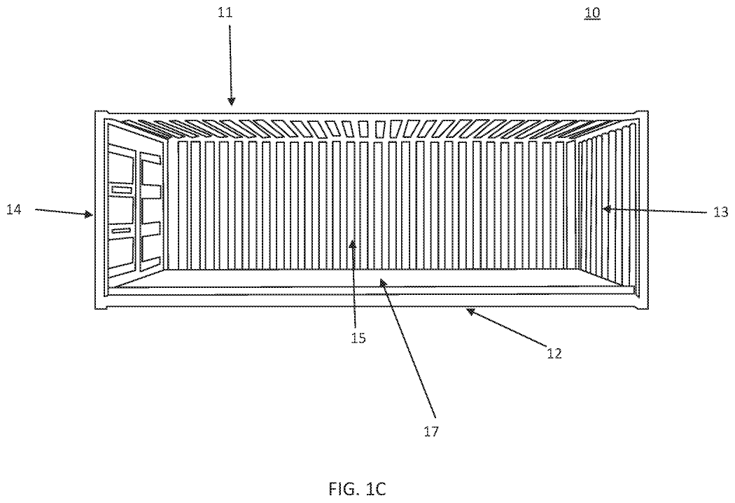

According to various embodiments in the figures, and particular to FIGS. 1A-1C, an intermodal container 10 is illustrated in accordance with some embodiments of the present disclosure. As shown in FIG. 1, intermodal container 10 comprises a top 11, a base 12, and sides 13, defining an interior cavity 15 of the intermodal container. In various embodiments, at least one side is configured with doors 14 to access the interior cavity 15 of the intermodal container.

As shown in FIG. 1, the top 11 and sides 13 of the intermodal container 10 may comprise corrugated interior to aid in support and structure. In various embodiments, the sides top 11, base 12, and sides 13 of intermodal container 10 may be made of metal, high strength plastic, or any suitably rigid and strong material. In some embodiments, intermodal container 10 may be made of metal harder than aluminum with corrosion resistant properties.

As shown in FIG. 1, according to various embodiments of the present disclosure, at least one solar pv panel 16 may be operably coupled to the outer exterior surface of the intermodal container. In various embodiments, a plurality of solar pv panels 16 may be operably coupled to the outer exterior portions of intermodal container 10 sides 13 and/or top 11. In some embodiments, solar pv panels 16 are disposed within a rectangular structure containing sides 13 and solar pv panels 16. In various embodiments, solar pv panels 16 are screwed, bolted, epoxied, mounted, and/or otherwise affixed to sides 13 and/or top 11. A person of ordinary skill in the art would understand that solar pv panels 16 may be operatively coupled to sides 13 and/or top 11 in a variety of different ways.

In various embodiments, the plurality of solar pv panels 16 are electrically coupled together. By way of example, the plurality of solar pv panels 16 may be electrically coupled in series or parallel. Solar pv panels 16 may comprise a plurality of solar cells wired together. By way of example, solar pv panels 16 may be made up of 60, 72, or 96 solar cells wired together. Solar pv panels 16 may be monocrystalline solar panels (Mono-SI), polycrystalline solar panels (Poly-SI), thin-film solar cells (TFSC), amorphous silicon solar cell (A-Si), biohybrid solar cell, cadmium telluride solar cell (CdTe), or concentrated PV cell (CVP or HCVP).

In some embodiments, solar pv panels 16 may comprise a solar skin. In various embodiments, the solar skin comprises aesthetic features useful for identifying intermodal container 10. In some embodiments, solar pv panels 16 comprise a solar skin on the outer exterior surface for identifying intermodal container 10 according to the ISO 6346 international standard. By way of example, information used to identify intermodal container may comprise, but is not limited to, serial number (with or without check digit), owner, country code, size, type and equipment category as well as any operational marks.

As shown in FIG. 1, according to various embodiments, intermodal container 10 further comprises a battery 17. In some embodiments, base 12 comprises an interior cavity where battery 17 may be stored. In various embodiments, battery 17 may comprise a structure similar to base 12 which defines the inner cavity 15 of intermodal container 10. According to various embodiments, battery 17 is electrically coupled to at least one solar pv panel 16 and configured to store solar energy collected from solar pv panel 16. In some embodiments, battery 17 is configured to be electrically coupled to a plurality of solar pv panels 16 and store solar energy collected from solar pv panel 16.

According to various embodiments, battery 17 may be of various capacity. Capacity as used herein refers to the total amount of electricity that the battery can store, typically measured in kilowatt-hours (kWh). In some embodiments, battery 17 may be disposed in a battery compartment (not shown) for housing battery 17. In various embodiments, battery 17 may be stackable (i.e., may include multiple batteries with solar-plus-storage system to get extra capacity). In some embodiments, battery 17 may have of various power ratings (i.e., the amount of electricity that a battery can deliver at one time).

Battery 17 may have comprise various chemical compositions (e.g., lead acid, lithium ion, nickel cadmium, saltwater etc.). Battery 17 consist of different lifespans, depth of charge, or other characteristic as would be understood by one of ordinary skill in the art. Although different battery types are disclosed, a person of ordinary skill in the art would understand that batteries may be made of many different materials and suitable for storing solar energy collected from solar pv panels 16 as described in this disclosure.

According to various embodiments, battery 17 may be electrically coupled to solar pv panels 16. In some embodiments, battery 17 is electrically coupled to solar pv panels 16 via a charge controller. In some embodiments, battery 17 may be connected to a power inverter. The power inverter as described herein takes DC power, either from the solar pv panels 16 directly or battery 17, and converts it into AC power.

In various embodiments, intermodal container 10 may comprise at least one electrical connection for electrically connecting two intermodal containers 10 together. In various embodiments, a plurality of electrical connections are disposed on the corners of either the top 11 or the bottom 12 of intermodal containers 10. According to various embodiments, the electrical connections may permit wireless power transfer from a battery 17 of intermodal container 10 to another battery of a different intermodal container. In this example, the electrical connection may provide the respective batteries 17 of a plurality of intermodal containers 10 to be wired in series or parallel. In various embodiments, intermodal container 10 may comprise a connection port for connecting two intermodal containers 10 together. In some embodiments, a plurality of connection ports may be integrated or disposed on intermodal container 10 such that a female or male connection aligns to a male or female connection in the same location when two intermodal containers are stacked on top of each other. By way of example, a top 11 portion of an intermodal container may comprise at least one female port and a bottom 12 portion of an intermodal container may comprise at least one male port. In this example, the connection ports permit electrically coupling two intermodal containers in series or parallel. In various embodiments, intermodal container 10 comprises a pressure switch. In some embodiments, the pressure switch is configured to open an access panel when intermodal containers 10 are stacked on top of each other. In some embodiments, connection ports are disposed behind an access panel such that when an intermodal container 10 is stacked on top of another intermodal container, the access panel opens and two intermodal containers 10 are electrically connected via the connection port.

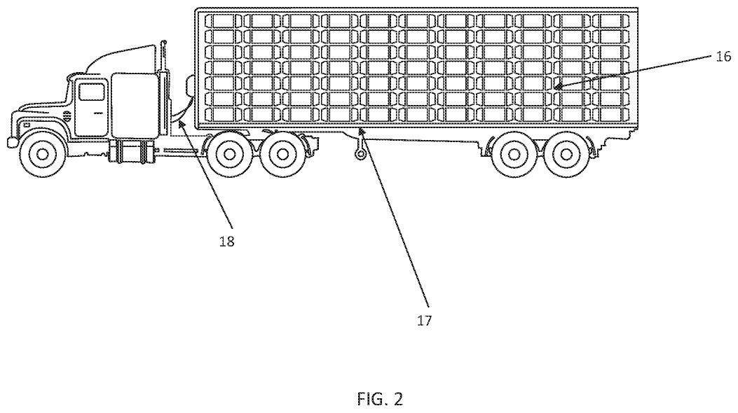

FIG. 2 is an intermodal container operably coupled to a truck in accordance with some embodiments of the present disclosure. In various embodiments, intermodal container 10 is configured to be physically and electrically coupled to a truck or semi-truck. In some embodiments, intermodal container 10 is electrically coupled to a truck or semi-truck via a trailer receptacle plug 18. In this embodiment, the battery 17 of intermodal container 10 is electrically coupled to the truck or semi-truck via a receptacle plug 18. In various embodiments, the receptacle plug 18 is defined by SAE recommended practice J560 standards. In other embodiments, intermodal container 10 may be electrically coupled to a truck or semi-truck via any suitable electronic connection means.

According to various embodiments of the present disclosure, intermodal containers 10 can advantageously power electrical motors, hybrid/electric engines or electric drive units from the power stored in battery 17. In various embodiments, intermodal containers 10 can power AC internal permanent magnet motors. In this example, at least one intermodal container 10 is electrically coupled to the electric or hybrid electric motor of a vehicle. In some embodiments, a plurality of intermodal containers 10 are electrically coupled together and configured to supply power from respective batteries 17 to

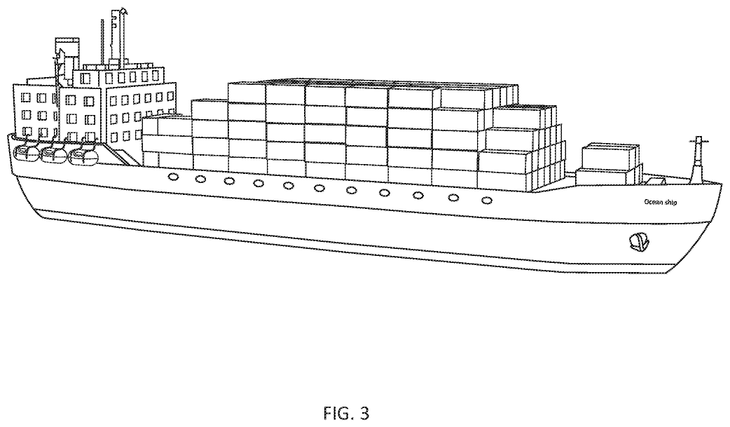

FIG. 3 is a plurality of intermodal containers disposed on a container ship in accordance with some embodiments of the present disclosure. In various embodiments, intermodal containers 10 may be electrically coupled to each other. As explained above, receptacle plug 18, which is defined by SAE recommended practice J560 standards, may be operably coupled to a corner of intermodal container 10. In various embodiments, a plurality of male and female ends of receptacle plug 18 may be operably coupled to the corners of intermodal container. In this embodiment, when a container 10 is disposed over another container 10, the male and female ends of receptacle plug 18 may be jointed. In various embodiments, a plurality of access panels (not shown) are disposed on intermodal container 10. The access panels may be used to protect the male and female ends of receptacle plugs 18 and triggered to open from the pressure of one intermodal container 10 being stacked on another intermodal container 10.

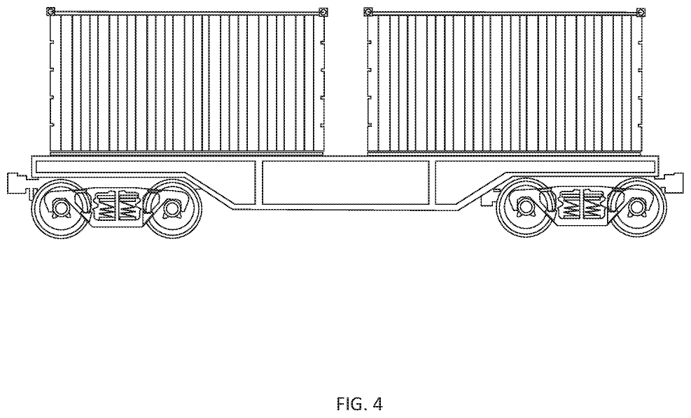

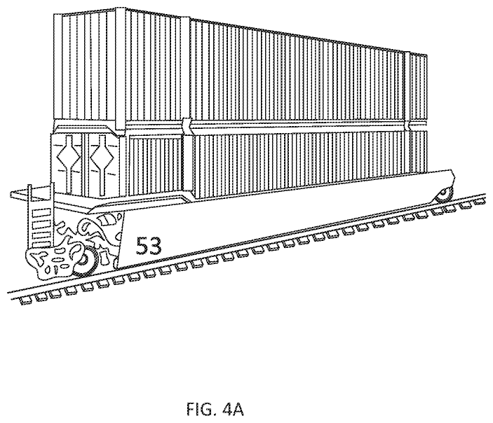

FIG. 4 is a plurality of intermodal containers disposed on railroad car in accordance with some embodiments of the present disclosure. FIG. 4A is a plurality of intermodal containers disposed on each other on railroad car in accordance with some embodiments of the present disclosure. In various embodiments, storage capacity of battery 17 of intermodal container 10 may be viewed on a gauge or digital readout panel of intermodal container 10. In some embodiments, storage capacity of battery 17 may be communicated wireless to a mobile device. In this embodiment, intermodal container 10 may contain a processor and a communication interface or circuitry for transmitting battery 17 storage information to a mobile device. The communication interface may include a wireless interface configured for short range communication, such as near field communication (“NFC”), Bluetooth, or other interface for communication via another wireless communication protocol configured to communicate with a mobile device or computer.

It may be emphasized that the above-described embodiments, are merely possible examples of implementations, and merely set forth a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

While various embodiments have been described, it is to be understood that the embodiments described are illustrative only and that the scope of the subject matter is to be accorded a full range of equivalents, many variations and modifications naturally occurring to those of skill in the art from a perusal hereof.

What is claimed is:

1. A storage container, comprising:
a plurality of walls coupled to one another to form a storage chamber therebetween and to define a plurality of intersection edges being formed at a corresponding boundary of two adjacent ones of the plurality of walls;
a base having a compartment defined by a planar exterior surface and a planar interior service;
a top, wherein said plurality of walls extend substantially vertically from the base to the top;
a battery stored in the compartment of the base;
a plurality of solar panels operably coupled to an exterior surface of the plurality of walls and electrically coupled to the battery;
at least one access panel disposed in the exterior corners of the top and base;
at least one plug receptacle disposed behind the at least one access panel such that each access panel is associated with one plug receptacle, wherein the at least one plug receptacle is electrically coupled to the battery
wherein the plurality of solar panels are configured to receive sunlight and convert to solar energy for storage in the battery.

2. The storage container of claim 1, further comprising a door for access to the storage chamber.

3. The storage container of claim 1, wherein the plurality of walls, exterior surface of the base, and the top are corrugated.

4. The storage container of claim 1, further comprising solar skin disposed over the plurality of solar panels.

5. The storage container of claim 1, wherein the plug receptacle is defined by SAE recommended practice J560 standards.

6. The storage container of claim 1, further comprising a pressure activation mechanism such that when a storage container is stacked on top of another storage container, the at least one access panel is opened such that alignment with another access panel permits the electrical coupling of two distinct storage containers via the plug receptacles.

7. The storage container of claim 1, further comprising a plug receptacle for electrically coupling the battery to an electric or hybrid electric engine.

8. The storage container of claim 1, further comprising a display for reading the electric storage information of the battery.

9. The storage container of claim 5, wherein when a plurality of storage containers stacked on top of each other, they are electrically coupled to each other via the plug receptacle such that an engine plug receptacle may be coupled to an electric or hybrid engine and is powered by each battery of the respective storage containers.

10. A solar energy storage system, comprising:
at least one container comprising:
a top, a bottom, and a plurality of sides;
at least one solar panel operably coupled to at least one of the plurality of sides of the at least one container;
a battery disposed with an interior cavity of the at least one container and electrically coupled to the at least one solar panel; and,
wherein the at least one solar panel is configured to receive sunlight and convert to solar energy for storage in the battery.

11. The solar energy storage system of claim 10, wherein the at least one container further comprises at least one access panel disposed on an exterior corner of the container top and bottom.

12. The solar energy storage system of claim 1, wherein the at least one container further comprises at least one plug receptacle disposed behind the at least one access panel such that each access panel is associated with one plug receptacle, wherein the at least on plug receptacle is electrically coupled to the battery.

13. The solar energy storage system of claim 12, wherein the at least one container further comprises a pressure activation mechanism such that when a container is stacked on top of another container, the at least one access panel is opened such that alignment with another access panel permits the electrical couple of the two storage containers via the plug receptacle.

14. The solar energy storage system of claim 13, wherein the at least one container further comprises an engine plug receptacle for electrically coupling the battery to an electric or hybrid electric engine.

15. The solar energy storage system of claim 14, wherein the at least one container further comprises a display for reading the electric storage capacity of the battery.

16. The solar energy storage system of claim 14, wherein when at least one container is stacked on top of another container, the containers are electrically coupled to each other via the plug receptacle such that an engine plug receptacle may be coupled to an electric or hybrid electric engine and is powered by each battery of the respective containers.

17. A method of powering an engine capable of receiving electricity, comprising the steps of:
receiving solar energy via at least one solar panel operably coupled to the exterior surface of a first intermodal container;
storing the solar energy received via the at least one solar panel in a battery disposed within an interior cavity of a container;
supplying power to an electric or hybrid electric engine using the stored solar energy from the battery.

18. The method of claim 17, further comprising the steps of:
stacking a second intermodal container onto said first intermodal container;
electrically coupling the battery of the first intermodal container and with a battery disposed within an interior cavity of the second intermodal containers via at least one plug receptacle;
supplying power to an electric or hybrid electric engine using the stored solar energy from each respective battery of the first and second intermodal containers.

19. The method of claim 17, wherein supplying power to an electric or hybrid electric engine is via an engine plug receptacle electrically coupled to a battery of the first or second intermodal container.

20. The method of claim 19, wherein the battery of the first and second intermodal container is disposed in a planar battery compartment.
